(19) United States
(12) Patent Application Publication
(10) Pub. No.: US 2005/0170284 A1
(43) Pub. Date: Aug. 4, 2005

(54) Photosensitive conducting composition for a plasma display panel

(76) Inventors: Beom-Wook Lee, Suwon-si (KR); Dong-Hee Han, Suwon-si (KR); Sang-Wook Shin, Suwon-si (KR); Jin-Hwan Jeon, Suwon-si (KR)

Correspondence Address: CHRISTIE, PARKER & HALE, LLP, PO BOX 7068, PASADENA, CA, 91109-7068, US

(21) Appl. No.: 11/044,979

(22) Filed: Jan. 26, 2005

(30) Foreign Application Priority Data
Jan. 29, 2004 (KR) 10-2004-0005879

(51) Int. Cl. G03C 1/492

(52) U.S. Cl. 430/270.1

(57) ABSTRACT

A photosensitive conducting composition for a plasma display panel includes a photosensitive conducting composition comprising a silane compound, a photosensitive organic vehicle, a glass frit and a conducting powder.

### CROSS REFERENCE TO RELATED APPLICATION

This application claims priority to and the benefit of Korean Patent Application No. 10-2004-0005879 filed in the Korean Intellectual Property Office on Jan. 29, 2004, the entire disclosure of which is incorporated herein by reference.

### FIELD OF THE INVENTION

The present invention relates to a photosensitive conducting composition for a plasma display panel, and more particularly to a photosensitive conducting composition for a plasma display panel capable of forming a rigid electrode.

### DESCRIPTION OF THE RELATED ART

In general, the address electrode, i.e., the bottom electrode, of a plasma display panel consists of a patterned conducting film. A screen printing method has conventionally been used to prepare the patterned conducting film. However, this method has recently been replaced by a photolithography method using a photosensitive conducting paste because the low resolution resulting from the screen printing method does not satisfy the demand for more high-performance and smaller displays.

In the photolithography method, a photosensitive conducting paste is printed on a glass substrate of a plasma display panel, etc. Then, after drying the printed substrate, a photomask is mounted on the substrate which is then exposed to light and cured using a UV exposure device. The unexposed, non-cured portion is then removed using a developing solution, and the remaining cured film is baked at a predetermined temperature to obtain a patterned conducting film.

Next, a dielectric layer is formed on the conducting film, and a barrier is formed on the dielectric layer. The barrier is formed by screen printing a barrier paste on the dielectric layer, drying it, attaching a dry film resist (DFR) on the dried barrier paste (laminating process), and exposing the DFR to UV light using an exposure device and a photomask. Crosslinking occurs at the portions of the DFR exposed to the UV so that the exposed part remains and the non-exposed part is removed during a subsequent developing process. As a result, a patterned DFR is obtained. Then, the surface of the patterned DFR is sandblasted using a sandblasting machine so that the portion with the DFR is protected and the portion without DFR is eroded away. As a result, a barrier is formed.

In general, the connector area of an address electrode is not damaged by a single sandblasting process. However, if a defect is found during inspection of the barrier, the barrier is removed and formed again. If the sandblasting process is repeated as in this case, the connector area of an address electrode may be separated or disconnected.

### SUMMARY OF THE INVENTION

In accordance with the present invention, a photosensitive conducting composition for a plasma display panel is provided with a strengthened address electrode that helps prevent separation or disconnection at the connector area of an address electrode even when sandblasted multiple times.

In accordance with the present invention, an electrode for a plasma display pane obtained by using the photosensitive conducting composition, is provided.

An exemplary embodiment of the present invention provides a photosensitive conducting composition for a plasma display panel. The composition includes a silane compound, a photosensitive organic vehicle, a glass frit, and a conducting powder.

Another exemplary embodiment of the present invention provides an electrode for a plasma display panel including SiO₂.

### BRIEF DESCRIPTION OF THE DRAWINGS

FIG. 1 is an optical micrograph of an address electrode produced by using a conducting composition according to Example 1 of the present invention after it has been sandblasted;

FIG. 2 is an optical micrograph of an address electrode produced by using a conducting composition according to Example 2 of the present invention after it has been sandblasted;

FIG. 3 is an optical micrograph of an address electrode produced by using a conducting composition according to Example 3 of the present invention after it has been sandblasted;

FIG. 4 is an optical micrograph of an address electrode produced by using a conducting composition according to Example 4 of the present invention after it has been sandblasted;

FIG. 5 is an optical micrograph of an address electrode produced by using a conducting composition according to Example 5 of the present invention after it has been sandblasted;

FIG. 6 is an optical micrograph of an address electrode produced by using a conducting composition according to Reference Example 1 after it has been sandblasted; and

FIG. 7 is an optical micrograph of an address electrode produced by using a conducting composition according to Comparative Example 1 after it has been sandblasted.

### DETAILED DESCRIPTION

The present invention relates to a photosensitive conducting composition used to form an address electrode when manufacturing a plasma display panel (hereinafter referred to as a PDP), which includes a silane compound. The silane compound enhances the adhesive force between the address electrode and the glass substrate, and increases the binding force of the conducting particles of the address electrode. The use of such a composition helps to prevent problems such as separation or disconnection of the connector area of the electrode during sandblasting.

The content of the silane compound is preferably 0.1-10.0 wt %, and more preferably 0.3-3.0 wt %. If the content of the silane compound is below 0.1 wt %, the address electrode may be separated or disconnected during the sandblasting process. If the content exceeds 10.0 wt %, the processing characteristics are deteriorated or the resistance of the electrode increases.

The silane compound oxidizes to form SiO₂ during a baking process. Thus, the conducting particles bind with the glass substrate. According to the invention, the conducting particles are prevented from being deformed or separated from the substrate during sandblasting.

The silane compound may be added as a monomer to a binder preparation, which is an organic vehicle, or it may be pre-coated on the glass substrate before printing the photosensitive conducting composition on the glass substrate. Considering the effectiveness of working and processing, it is preferably used by adding it to the binder preparation.

The silane compound is represented by Formula 1. 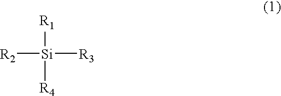
where R₁, R₂, R₃ and R₄ are identical or different, each selected from the group consisting of H, alkyls, vinyl, silanes, alkyl halides, halides, aryls, alkoxys, ethers (alkoxy alkyls), epoxides, alcohols, esters, amines and acids.

The silane compound represented by Formula 1 may be an aliphatic or an aromatic compound. In one embodiment, it is preferred that it has a boiling point of at least 150° C. so that it is not volatilized during preparation of the composition. When it is in a solid state, the silane compound must be soluble in the organic vehicle. When it is in liquid state, the silane compound must be miscible with the organic vehicle, so that no phase separation, deterioration of the composition, etc., occurs.

Examples of the silane compound are compounds where at least one of R₁-R₄ is H or an alkyl such as tripropylsilane, triisopropylsilane, tributylsilane, triisobutylsilane, trihexylsilane, dimethyloctadecylsilane, tetraethylsilane, or diisopropyloctylsilane; compounds where at least one of R₁-R₄ is a vinyl such as triethylvinylsilane, allyltrimethylsilane, allyltriisopropylsilane, trimethyl(3-methyl-2-butyl)silane, diallyldimethylsilane, tetravinylsilane, tetraallylsilane, triphenylvinylsilane, or allyltriphenylsilane; compounds where at least one of R₁-R₄ is a silane such as bis(trimethylsilyl)methane, tris(trimethylsilyl)methane, hexamethyldisilane, or tetrakis(trimethylsilyl)silane; compounds where at least one of R₁-R₄ is an alkyl halide or a halide such as bis(chloromethyl)dimethylsilane, chlorodiisopropylsilane, 1,2-bis(chlorodimethylsilyl)ethane, chlorotriethylsilane, or chlorodimethyloctylsilane; compounds where at least one of R₁-R₄ is an aryl such as dimethylphenylsilane, 1,2-bis(dimethylsilyl)benzene, 1,4-bis(dimethylsilyl)benzene, phenyltrimethylsilane, diphenylsilane, diphenylmethylsilane, diphenylmethylsilane, triphenylsilane, tribenzylsilane, benzyltrimethylsilane, or benzyloxytrimethylsilane; compounds where at least one of R₁-R₄ is an alkoxy or an ether group such as (methoxymethyl)trimethylsilane, ethoxytrimethylsilane, propoxytrimethylsilane, methoxydimethyloctylsilane, methoxydimethyloctadecylsilane, dimethoxymethyloctylsilane, trimethoxypropylsilane, isobutyltrimethoxysilane, octyltrimethoxysilane, octadecyltrimethoxysilane, methyltrimethoxysilane, ethyltrimethoxysilane, isobutyltriethoxysilane, octyltriethoxysilane, diethoxyphenylsilane, phenyltrimethoxysilane, phenyltriethoxysilane, vinyltrimethoxysilane, triethoxyvinylsilane, allyltriethoxysilane, or tris(2-methoxyethoxy)vinylsilane; compounds where at least one of R₁-R₄ is an epoxide such as 3-glycidoxypropyltrimethoxysilane, diethoxy(3-glycidyloxypropyl)methylsilane, or trimethoxy[2-(7-oxabicyclo[4.1.0]hept-3-yl)ethyl]silane; compounds where at least one of R₁-R₄ is an alcohol such as (trimethylsilyl)methanol, 1-(trimethylsilyl)ethanol, 2-(trimethylsilyl)ethanol, 3-(trimethylsilyl)-1-propanoltriethylsilanol, t-butyldimethylsilanol, 5-(t-butyldimethylsilyloxy)-1-pentanol, or 2-(methyldiphenylsilyl)ethanol; compounds where at least one of R₁-R₄ is an ester such as trimethylsilyl acetate, trimethylsilylmethyl acetate, methyl(trimethylsilyl)acetate, ethyl(trimethylsilyl)acetate, t-butyl(trimethylsilyl)acetate, ethyl 3-(trimethylsilyl) priopionate, 2-[(trimethylsilyl)methyl]-2-priopene-1-yl acetate, trimethylsilyl methacrylate, 2-(trimethylsilyloxy)ethyl methacrylate, 3-(trimethoxysilyl)propyl methacrylate, methyltrimethylsilyl malonate, ethyltrimethylsilyl malonate, or bis(trimethylsilyl) malonate; compounds where at least one of R₁-R₄ is an amine such as N,N-diethyl(trimethylsilylmethyl)amine, N-t-butyltrimethylsilylamine, N,N-diethyltrimethylsilylamine, 1,1′-ethylenebis(N,N,1,1-tetramethyl)silanamine, 1-(trimethylsilyl)pyrrolidine, or 4-(trimethylsilyl)morpholine; compounds where at least one of R₁-R₄ is an acid such as (trimethylsilyl)acetic acid or 3-(trimethylsilyl)propionic acid; compounds where at least one of R₁-R₄ is a nitryl group such as 3-(triethoxysilyl)propionitrile or t-butyldiphenylsilyl cyanide; and compounds where at least one of R₁-R₄ is an isocyanate group such as 3-(triethoxysilyl)propyl isocyanate. These compounds may be used alone or in combination.

The conducting powder is used to give conductivity to the baked, patterned film. Exemplary materials are silver, gold, copper, aluminum, or alloys thereof. Although the shape of the conducting powder particle is not particularly limited, a spherical shape provides high packing ratio and UV transmission. The conducting powder preferably has a surface area of 0.3-2.0 m²/g and desirably has an average particle size of 0.1-5.0 μm. If the surface area is smaller than 0.3 m²/g or if the average particle size is larger than 5.0 μm, the resultant film pattern tends to be nonlinear and have high resistance. If the surface area is larger than 2.0 m²/g or if the average particle size is below 0.1 μm, dispersibility of the paste and exposure sensitivity may be poor.

In one embodiment, the content of the conducting powder is preferably 40-80 wt %. If the content of the conducting powder is below 40 wt %, severe contraction of the linewidth of the conducting film or disconnection may occur. If it exceeds 80 wt %, the desired pattern is difficult to obtain because of insufficient crosslinkage due to poor printing characteristics and reduced light transmission.

The glass frit is baked during the baking process, which enhances the adhesive force between the conducting powder and the glass substrate. Exemplary glass frits include those that are PbO—SiO₂-based, PbO—B₂O₃—SiO₂-based, ZnO—SiO₂-based, ZnO—B₂O₃—SiO₂-based, Bi₂O₃—SiO₂-based, or Bi₂O₃—B₂O₃—SiO₂-based. It is also possible to use a combination of the above constituents. The shape of the glass frit particle is not particularly limited, but it is preferred that the maximum particle size is 5.0 μm. If the particle size is larger than 5 μm, the baked film tends to be non-uniform and nonlinear.

In one embodiment, the glass frit has a thermal expansion coefficient from 50×10⁻⁷ to 100×10⁻⁷. If the thermal expansion coefficient is smaller than 50×10⁻⁷, the adhesive force between the baked film and the glass substrate may be reduced. If it is larger than 100×10⁻⁷, the glass frit tends to concentrate at the center of the baked film, causing the edges of the film to curl upwardly (edge curl).

In one embodiment, the content of the glass frit is preferably 0.5-5.0 wt %. If the content of the glass frit is below 0.5 wt %, the adhesive force between the conducting film and the glass substrate is reduced so that the conducting film may be peeled off in the succeeding processes. If it exceeds 5.0 wt %, resistance of the conducting film increases.

The vehicle or the organic component of the photosensitive conducting composition includes a binder, a crosslinking agent, a photoinitiator and a solvent. Further additives may also be added.

For the binder, a copolymer of a monomer having an acid group or a carboxyl group, and at least one other monomer is generally used, so that the photosensitive conducting composition can be developed in an alkaline solution. Monomers having a carboxyl group include acrylic acid, methacrylic acid, fumaric acid, maleic acid, vinylacetic acid, or anhydrides thereof. Examples of the other monomer copolymerized with the monomer with the carboxyl group include methyl acrylate, methyl methacrylate, ethyl acrylate, ethyl methacrylate, n-butyl acrylate, n-butyl methacrylate, isobutyl acrylate, isobutyl methacrylate, 2-hydroxyethyl acrylate, 2-hydroxyethyl methacrylate, ethylene glycol monomethyl ether acrylate, and ethylene glycol monomethyl ether methacrylate.

In one embodiment, the copolymer has a weight average molecular weight ranging from 5,000 to 100,000 g/mol and an acid value ranging from 20 to 100 mg KOH/g. If the weight average molecular weight of the copolymer is smaller than 5,000 g/mol, the composition may have poor printing characteristics. If it is larger than 100,000 g/mol, the developing characteristics may worsen. If the acid value of the copolymer is smaller than 20 mg KOH/g, the developing characteristics may be poor. If it exceeds 100 mg KOH/g, even the unexposed part may be developed.

Also, a product obtained by reacting the carboxyl group of the above copolymer with an unsaturated ethylenic compound with a site for crosslinkage may be used as the binder. Examples of such unsaturated ethylenic compounds include glycidyl methacrylate, 3,4-epoxycyclohexylmethyl methacrylate, and 3,4-epoxycyclohexylmethyl acrylate.

Cellulose or derivatives thereof such as hydroxymethylcellulose, hydroxyethylcellulose, carboxymethylcellulose, carboxyethylcellulose, carboxyethylmethylcellulose, may be used as the binder to improve film leveling or the thixotropic characteristics.

In one embodiment, the content of the binder is from 5 to 15 wt %. If the content of the binder is below 5 wt %, the printing characteristics may be poor. If it exceeds 15 wt %, the developing characteristics may be poor and residue may remain around the baked film.

For the crosslinking agent, a multifunctional monomer such as ethylene glycol diacrylate, ethylene glycol dimethacrylate, trimethylolpropane triacrylate, trimethylolpropane trimethacrylate, tetramethylolpropane tetraacrylate, tetramethylolpropane tetramethacrylate, pentaerythritol triacrylate, pentaerythritol trimethacrylate, pentaerythritol tetraacrylate, or pentaerythritol tetramethacrylate may be used. The crosslinking agent may be used alone or in combination. The content of the crosslinking agent is preferably 20-100 parts by weight based on 100 parts by weight of the binder. If the content of the crosslinking agent is below 20 parts by weight, the exposure sensitivity may be poor or a crack may appear in the pattern during the developing process. If it exceeds 100 parts by weight, the linewidth becomes larger after developing, so that the pattern becomes unclear and residue may remain after baking.

Examples of the photoinitiator include benzophenone, obenzoylmethyl benzoate, 4,4-bis(dimethylamine)benzophenone, 4,4-bis(diethylamino)benzophenone, 2,2-diethoxyacetophenone, 2,2-dimethoxy-2-phenyl-2-phenylacetophenone, 2-methyl-[4-(methylthio)phenyl]-2-morpholinopropa-1-one, 2-benzyl-2-dimethylamino-1-(4-morpholinophenyl)-1-butanone, bis(2,6-dimethoxybenzoyl)-2,4,4-trimethylpentylphosphine oxide, and bis(2,4,6-trimethylbenzoyl)phenylphosphine oxide. These compounds may be used alone or in combination. The content of the photoinitiator is preferably 1-50 parts by weight based on 100 parts by weight of the crosslinking agent. If the content of the photoinitiator is below 1.0 part by weight, the exposure sensitivity of the paste may decrease. If it exceeds 50 parts by weight, the linewidth of the exposed part may decrease.

Possible additives may include a sensitizer that increases sensitivity, a polymerization inhibitor or an antioxidant that improves storage characteristics of the paste, a UV absorbent that improves resolution, a defoamer that reduces foaming inside the paste, a disperser that improves dispersibility, a leveling agent that improves film flatness during printing, or a plasticizer that improves the thixotropic properties. Such additives, if used at all, may be used alone or in combination.

The solvent is not specially limited. In one embodiment, a solvent is used that is capable of dissolving the binder and the initiator, and that is miscible with the crosslinking agent and other additives, and that has a boiling point of 150° C. or higher. If the boiling point is below 150° C., the solvent may evaporate during the paste manufacturing process, especially during the 3-roll milling process. Also, if the solvent is evaporated too fast during printing, the desired pattern may not be obtained. Exemplary solvents include ethylcarbitol, butylcarbitol, ethylcarbitol acetate, butylcarbitol acetate, texanol, terpene oil, dipropylene glycol methyl ether, dipropylene glycol ethyl ether, dipropylene glycol monomethyl ether acetate, □-butyrolactone, cellosolve acetate, butylcellosolve acetate, and tripropylene glycol. These solvents may be used alone or in combination.

The photosensitive conducting composition of the present invention is used to form an electrode pattern of a plasma display panel. Hereinafter, one embodiment of a pattering procedure using the photosensitive conducting composition of the present invention will be illustrated. However, in the present invention, a pattering procedure is not limited thereto.

A plurality of grooves is formed on a glass substrate with equal spacing therebetween. Then, the photosensitive conducting composition of the present invention is coated on the entire surface of the glass substrate, including the grooves. The coating may be performed by any known method, including screen printing, bar coating or roll coating. Next, the coated substrate is exposed using a photomask and developed. Then the substrate is baked in a baking furnace. The baking temperature may be controlled according to the type of the substrate used. For example, a baking temperature of 400-600° C. is preferred for a glass substrate, and 400-1000° C. is preferred for a ceramic substrate. If the baking temperature is below 400° C., organic materials may remain because they are not completely decomposed during baking. Also, the glass frit may not be softened or fusion of the conducting particles may be incomplete. If the baking temperature exceeds 600° C. or 1000° C., the glass substrate may be deformed. During the baking process, the silane compound included in the photosensitive conducting composition of the present invention is oxidized to SiO₂, thereby binding the conducting particles to the glass substrate. As a result, according to the procedure, an electrode including SiO₂ is obtained.

Hereinafter, the present invention is described in more detail through examples. The following examples are only for the understanding of the present invention, however, they do not limit the present invention.

### EXAMPLES 1-5, REFERENCE EXAMPLES 1-2, AND COMPARATIVE EXAMPLE 1

A photosensitive conducting paste was prepared by mixing the components presented in Table 1, stirring with a stirrer, and kneading with a 3-roll mill. During mixing, the vehicle components were mixed first, and then the glass frit and the conducting material were added. The numbers presented in Table 1 are in wt %. In Table 1, the weight of the binder is the value including that of the solvent (ethylcarbitol acetate) used in copolymerization. The net weight of the binder was 8 wt %. The detailed composition of the binder is presented in Table 2.

TABLE 1

| | Example | Example | Example | Example | Example | Reference | Reference | Comparative. |
|---|---|---|---|---|---|---|---|---|
| Components | 1 | 2 | 3 | 4 | 5 | Example 1 | Example 2 | Example 1 |
| Conducting | 63.0 | 63.0 | 63.0 | 63.0 | 63.0 | 63.0 | 63.0 | 63.0 |
| material | | | | | | | | |
| Glass frit | 3.0 | 3.0 | 3.0 | 3.0 | 3.0 | 3.0 | 3.0 | 3.0 |
| Binder | 16.0 | 16.0 | 16.0 | 16.0 | 16.0 | 16.0 | 16.0 | 16.0 |
| Crosslinking | 4.0 | 4.0 | 3.0 | 4.0 | 3.0 | 4.0 | 3.0 | 4.0 |
| agent A | | | | | | | | |
| Crosslinking | 2.0 | 2.0 | 1.0 | 2.0 | 1.0 | 2.0 | 1.0 | 2.0 |
| agent B | | | | | | | | |
| Initiator A | 0.8 | 0.8 | 0.8 | 0.8 | 0.8 | 0.8 | 0.8 | 0.8 |
| Initiator B | 0.7 | 0.7 | 0.7 | 0.7 | 0.7 | 0.7 | 0.7 | 0.7 |
| Plasticizer | 1.0 | 1.0 | 1.0 | 1.0 | 1.0 | 1.0 | 1.0 | 1.0 |
| Solvent | 6.5 | 6.5 | 6.5 | 6.5 | 5.5 | 7.45 | 0.5 | 7.5 |
| Storage | 2.0 | 2.0 | 2.0 | — | — | 2.0 | — | 2.0 |
| stabilizer | | | | | | | | |
| Silane | 1.0 | — | — | — | — | 0.05 | — | — |
| compound 1 | | | | | | | | |
| Silane | — | 1.0 | — | — | — | — | — | — |
| compound 2 | | | | | | | | |
| Silane | — | — | 3.0 | — | 3.0 | — | 5.5 | — |
| compound 3 | | | | | | | | |
| Silane | — | — | — | 3.0 | 3.0 | — | 5.5 | — |
| compound 4 | | | | | | | | |

In Example 1, 1.0 wt % of a silane compound having an alkyl group and an alkoxy group (silane compound 1) per 100 wt % of the paste was added. In Example 2, 1.0 wt % of a silane compound having an alkoxy group and a vinyl group (silane compound 2) was added. In Example 3, 3.0 wt % of a silane compound having a methacrylate group (silane compound 3) was added and the content of the crosslinking agent was reduced by 2.0 wt %, because the methacrylate group contributes to crosslinking. In Example 4, 3.0 wt % of a silane compound having a tertiary amine group (silane compound 4) was added and the storage stabilizer was not added, because the tertiary amine group contributes to storage stabilization. In Example 5, 3.0 wt % of each of silane compounds 3 and 4 were added, the content of the crosslinking agent was reduced, and the storage stabilizer was not added. In Reference Example 1, a trace amount of silane compound 1 was added to test the minimum content. In Reference Example 2, excess silane compounds were added to test the maximum content. In Comparative Example 1, no silane compound was added to compare the damage to the address electrode during sandblasting.

Each constituent presented in Table 1 is described in Table 2 below.

TABLE 2

| Constituents | Composition |
|---|---|
| Conducting | Ag powder, spherical, surface area: 0.65 m²/g, |
| material | average particle size: 1.7 μm |
| Glass frit | PbO—SiO₂, amorphous, maximum size: 3.4 μm |
| Binder | Polymer [poly(MMA-co-MAA), molecular weight: |
| | 15,000 g/mol, acid value: 55 mg KOH/g] + solvent |
| | (ethylcarbitol acetate), (weight proportion = 5:5) |
| Crosslinking | Trimethylolpropane trimethacrylate |
| agent A | |
| Crosslinking | Pentaerythritol tetramethacrylate |
| agent B | |
| Initiator A | 2,2-Dimethoxy-2-phenyl-2-phenylacetophenone |
| Initiator B | 2-Benzyl-2-dimethylamino-1-(4- |
| | morpholinophenyl)-1-butanone |
| Solvent | Ethylcarbitol acetate |
| Plasticizer | Dioctyl phthalate |
| Storage | N,N-dimethylaminoethyl benzoate |
| stabilizer | |
| Silane | Ethyltriethoxysilane |
| compound 1 | |
| Silane | Tris(2-methoxyethoxy)vinylsilane |
| compound 2 | |
| Silane | 2-(Trimethylsilyloxy)ethyl methacrylate |
| compound 3 | |
| Silane | N,N-Diethyl(trimethylsilylmethyl)amine |
| compound 4 | |

For each paste prepared with the composition given in Table 1, the following procedures were followed and damage to the address electrode after sandblasting was evaluated.
(1) Printing: Screen printing on a 20 cm×20 cm glass substrate.
(2) Drying: Drying in a 100° C. oven for 15 minutes.
(3) Exposing: Exposing at 300 mJ/cm² using a UV exposure device equipped with a high-pressure mercury lamp.
(4) Developing: Developing by spraying a 0.4% sodium carbonate solution at a nozzle pressure of 1.5 kgf/cm².
(5) Baking: Baking at 580° C. for 12 minutes using an electric baking furnace to form an address electrode.
(6) Sandblasting: Sandblasting the connector area of the address electrode by spraying a sandblasting powder at a pressure of 1.2 kgf/cm² for 1 minute using a sandblasting machine manufactured by the inventors.
(7) Evaluation: The sandblasted area was observed with an optical microscope.

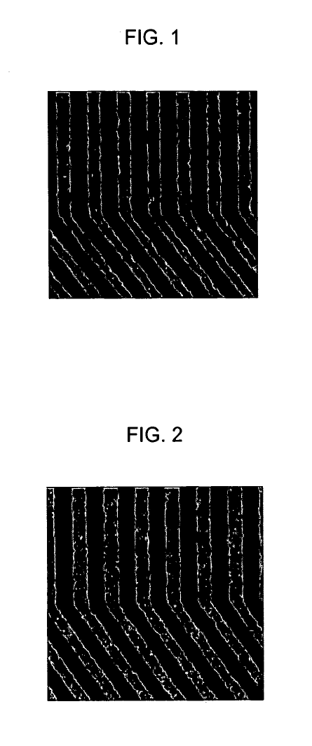

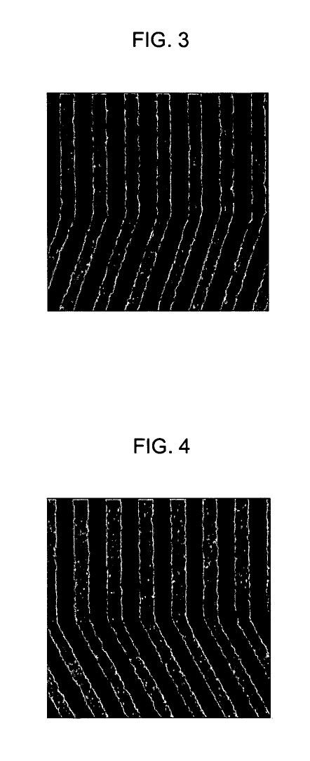

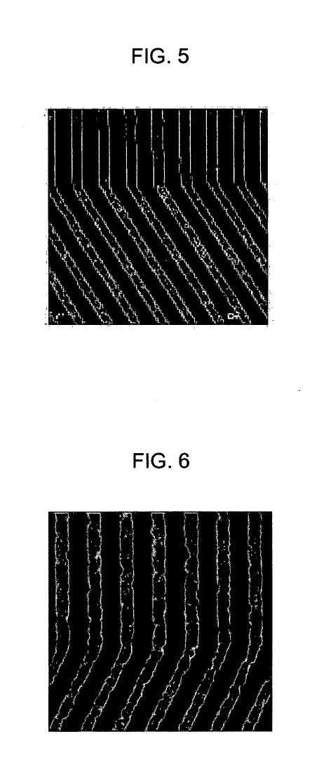

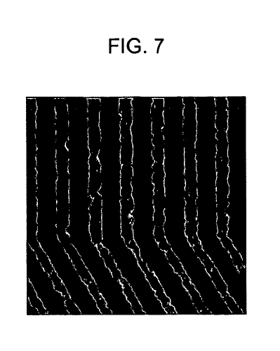

Optical micrographs for Examples 1-5, Reference Example 1, and Comparative Example 1 are presented in FIGS. 1-7. Reference Example 2 was omitted because of poor developing characteristics.

As seen in FIGS. 1-7, the paste not including a silane compound (Comparative Example 1) and the paste including a small amount of the silane compound (Reference Example 1) experienced severe damage at the connector area of the electrode. The paste in which the most silane compound was included (Example 5) experienced little damage at the connector area. Other Examples showed similar results.

As is apparent from the above description, a photosensitive conducting composition for a plasma display panel of the present invention that includes a silane compound provides improved adhesive force between the conducting particles including the electrode and the glass substrate as the silane compound is oxidized to SiO₂ during the baking process, and the binding force between the conducting particles is enhanced. As a result, deformation or separation of conducting particles from the substrate at the connector area can be prevented.

While the present invention has been described in detail referring to the preferred embodiments, those skilled in the art will appreciate that various modifications and substitutions can be made thereto without departing from the spirit and scope of the present invention as set forth in the appended claims.

1. A photosensitive conducting composition for a plasma display panel, comprising:
a silane compound;
a photosensitive organic vehicle;
a glass frit; and
a conducting powder.

2. The photosensitive conducting composition for a plasma display panel of claim 1, wherein the silane compound is present in an amount from 0.1 to 10.0 wt %.

3. The photosensitive conducting composition for a plasma display panel of claim 1, wherein the silane compound is represented by Formula 1: 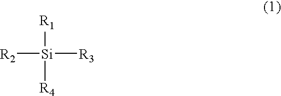
where R₁, R₂, R₃ and R₄ are identical or different, each selected from the group consisting of H, alkyls, vinyl, silanes, alkyl halides, halides, aryls, alkoxys, ethers (alkoxy alkyls), epoxides, alcohols, esters, amines, and acids.

4. The photosensitive conducting composition for a plasma display panel of claim 1, wherein the photosensitive organic vehicle is present in an amount from 15 to 60 wt %.

5. The photosensitive conducting composition for a plasma display panel of claim 1, wherein the photosensitive organic vehicle comprises a binder, a crosslinking agent, a photoinitiator, an additive, and a solvent.

6. The photosensitive conducting composition for a plasma display panel of claim 1, wherein the glass frit is present in an amount from 0.5 to 5.0 wt %.

7. The photosensitive conducting composition for a plasma display panel of claim 1, wherein the conducting powder is present in an amount from 40 to 80 wt %.

8. An electrode for a plasma display panel comprising SiO₂.
